(19) United States
(12) Patent Application Publication
(10) Pub. No.: US 2023/0385299 A1
(43) Pub. Date: Nov. 30, 2023

(54) GREENHOUSE GAS REDUCTION AUTOMATION PROCESS

(71) Applicant: SAUDI ARABIAN OIL COMPANY, Dhahran (SA)

(72) Inventors: Hussain A. Al Rasheed, Dhahran (SA); Khaled H. Al Qahtani, Dhahran (SA); Abdulhakim . Al Habib, Dhahran (SA); Sultan T. Halawani, Dhahran (SA); Nadia M. Al Olyani, Dhahran (SA); Maryam A. Bahmaid, Dhahran (SA)

(73) Assignee: SAUDI ARABIAN OIL COMPANY, Dhahran (SA)

(21) Appl. No.: 17/804,534

(22) Filed: May 27, 2022

(51) Int. Cl. G06F 16/25; G06F 16/28; G06Q 50/26

(52) U.S. Cl. CPC G06F 16/252; G06F 16/258; G06F 16/288; G06Q 50/26

(57) ABSTRACT

A method includes building, using a computer processor, a historical greenhouse gas emissions database by integrating historical greenhouse gas emissions data from a plurality of sources for a plurality of sectors in an entity. The method further includes training, using the computer processor, an advanced analytics algorithm with the historical greenhouse gas emissions database, generating, using the computer processor and the advanced analytics algorithm, a recommendation for each sector of the entity, and applying each recommendation to each sector of the entity to reduce greenhouse gas emissions.

### BACKGROUND

The Earth is currently warming at a faster rate than the historical warming rate. This increase in rate is primarily driven by human activities. Specifically, human activities have exponentially increased the abundance of heat-trapping gases in the atmosphere which have, in-turn, created a greenhouse effect. These heat-trapping gases are called greenhouse gas. Unnatural heating of the Earth may negatively affect the environment and the health and safety of the human population. As such, it is necessary to provide systems and methods that reduce the amount of greenhouse gas emitted by human-driven activities.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments methods and systems for reducing greenhouse gas emissions. The method includes building, using a computer processor, a historical greenhouse gas emissions database by integrating historical greenhouse gas emissions data from a plurality of sources for a plurality of sectors in an entity. The method further includes training, using the computer processor, an advanced analytics algorithm with the historical greenhouse gas emissions database, generating, using the computer processor and the advanced analytics algorithm, a recommendation for each sector of the entity, and applying each recommendation to each sector of the entity to reduce greenhouse gas emissions.

The system includes an entity, a plurality of emission offset devices, and a non-transitory computer readable medium. The entity has a plurality of sectors, wherein each sector has historical greenhouse gas emissions data retrieved from a plurality of sources. The non-transitory computer readable medium is coupled to the plurality of sources and the plurality of emission offset devices. The non-transitory computer readable medium stores instructions comprising functionality for building a historical greenhouse gas emissions database by integrating the historical greenhouse gas emissions data from the plurality of sources for the plurality of sectors in the entity, training an advanced analytics algorithm with the historical greenhouse gas emissions database, generating, using the advanced analytics algorithm, a recommendation for each sector of the entity, and applying each recommendation to each sector of the entity to reduce greenhouse gas emissions.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an entity having a plurality of sectors in accordance with one or more embodiments.

FIG. 2 shows a flowchart in accordance with one or more embodiments.

FIG. 3 shows a program flowchart of the advanced analytics algorithm in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Corporations are the largest category of the human population that create greenhouse gas emissions as direct or indirect results of their operations. In order to effectively decrease the overall emissions of greenhouse gas by humans, corporations must be able to decrease their contribution to greenhouse gas emissions. Further, it is a current goal for corporations to reach net-zero emissions by a certain threshold. As such, embodiments presented herein outline systems and methods that may be used by entities, such as corporations or companies, to reduce their greenhouse gas emissions and potentially reach net-zero emissions.

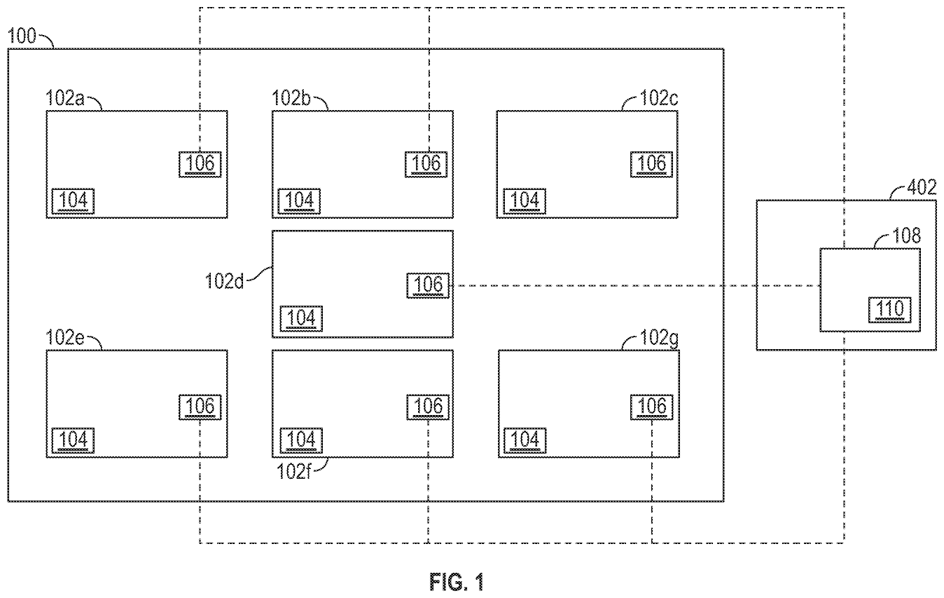

FIG. 1 shows an entity (100) having a plurality of sectors (102a-g) in accordance with one or more embodiments. Herein, the terms “entity” and “sector” are not meant to be limiting. “Entity” may be interpreted to mean any organization type of any size that directly or indirectly creates greenhouse gas emissions. For example, the entity (100) may be a large corporation, or the entity (100) may be a local business. “Sector” may be interpreted to mean distinct sections of an entity such as supply chain, transportation, etc. Further, while multiple sectors are shown, an entity (100) may only have one sector (102a-g) that defines the extent of the entity (100) without departing from the scope of the disclosure herein.

For purposes of an example and in accordance with one or more embodiments, the entity (100) has a plurality of sectors (102a-g), in this example seven sectors: a first sector (102a), a second sector (102b), a third sector (102c), a fourth sector (102d), a fifth sector (102e), a sixth sector (1020, and a seventh sector (102g). In further embodiments, the first sector (102a) may be the supply chain section of the entity (100); the second sector (102b) may be the transportation section of the entity (100); the third sector (102c) may be the manufacturing section of the entity (100); the fourth sector (102d) may be the information technology section of the entity (100); the fifth sector (102e) may be the community services section of the entity (100); the sixth sector (1020 may be the construction section of the entity (100); and the seventh sector (102g) may be the non-industrial section (agriculture, mining, health, aerospace, military, etc.) of the entity (100).

Each sector (102a-g) has historical greenhouse gas emissions data (110) that, summed together, equal the historical greenhouse gas emissions for the entire entity (100). The historical greenhouse gas emissions data (110) may be measured in total contributions or in rates and the rates may be measured as daily, yearly, monthly, etc. rates without departing from the scope of the disclosure herein. Further, the historical greenhouse gas emissions data (110) may be greenhouse gas that has been emitted directly or indirectly by the sector (102a-g).

In one or more embodiments, the historical greenhouse gas emissions data (110) for each sector (102a-g) is retrieved from a plurality of sources (106). These sources (106) may be shared across sectors (102a-g) and/or the sources (106) may be specialized for each sector (102a-g). Further, each sector (102a-g) may have more than one source (106) providing the historical greenhouse gas emissions data (110). The sources (106) may be the Internet of Things, Plant Information, Web APIs restful and SOAP, Building Management Systems, ERP systems, AVL, GIS, Excel sheets, video cameras, remote sensors, satellite imaging, digital documents, Non-ERP Systems, scanned documents, SCADA, text files, user sources, etc. Further, current/real-time greenhouse gas emission data (110) may be constantly and/or automatically obtained from said sources (106).

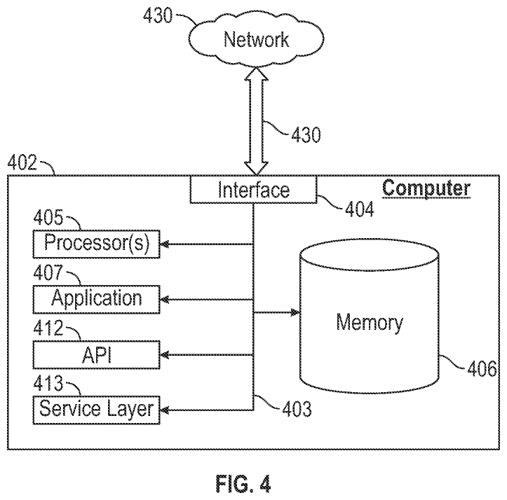

In accordance with one or more embodiments, the plurality of sources (106) may be combined into a database (108) that gathers and integrates all of the greenhouse gas emission data (110) for each sector (102a-g). How the greenhouse gas emission data (110) from each source (106) is entered into the database (108) depends on the source (106). For example, greenhouse gas emissions data (110) from an excel sheet source (106) may be digitally uploaded onto the database (108). In further embodiments, the database (108) may be located on a computer (402) system. The computer (402) system is further outlined in FIG. 4.

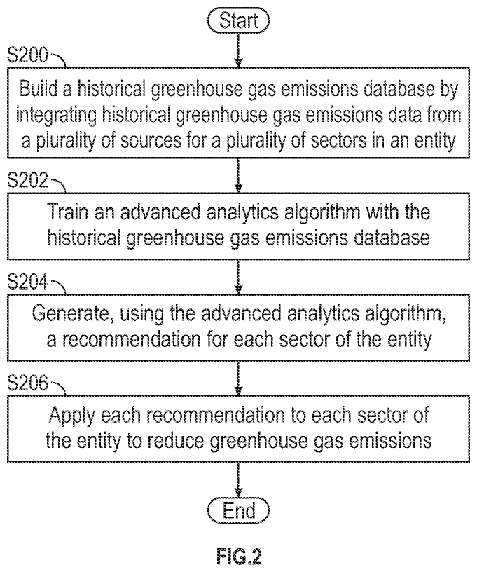

FIG. 1 also shows each sector (102a-g) being associated with at least one emission offset device (104). Emission offset devices (104) are physical devices that can absorb/capture/break down greenhouse gas. In accordance with one or more embodiments, the emission offset devices (104) may be direct air capture devices, trees, and/or carbon capture and storage devices. The emission offset devices (104) may be used to “offset” the greenhouse gas emitted by each sector (102a-g). In order to reduce greenhouse gas emissions and obtain net-zero emissions, the entity (100) may have to employ both emission reduction methods and emission offset devices. The specific emission reduction methods and the number and type of emission offset devices (104) associated with each sector (102a-g) may be determined using the method outlined below in FIG. 2.

FIG. 2 shows a flowchart in accordance with one or more embodiments. The flowchart outlines a method for reducing greenhouse gas emissions. While the various blocks in FIG. 2 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially, a historical greenhouse gas emissions database (108) is built by integrating historical greenhouse gas emissions data (110) from a plurality of sources (106) for a plurality of sectors (102a-g) in an entity (100) (S200). The historical greenhouse gas emissions database (108) may be used to categorize and sum the historical greenhouse gas emissions data (110) to determine a total greenhouse gas emissions value for each sector (102a-g) as well as for the entity (100). These greenhouse gas emissions values may be used to assign a performance indicator for each sector (102a-g) and the entity (100). The performance indicator may be based on current or historical emissions values from across the entity (100) and may be used to compare the sectors (102a-g) with one another and with future emissions target values.

In accordance with one or more embodiments, the entity (100) may be a corporation having seven sectors (102a-g) as described in FIG. 1. For example, the first sector (102a) may have historical greenhouse gas emissions data (110) relating to exported goods, imported goods, transportation of supply chain products, storage and logistics, scheduling, dispatching, and delivery.

The second sector (102b) may have historical greenhouse gas emissions data (110) relating to planned vs scheduled trips and on-going trips. Specifically, the historical greenhouse gas emissions data (110) for the trips include fuel consumption, distance, speed, route, fuel type, destinations, weight and type of the cargo, total passengers, model of the vehicle, condition of the vehicle, engine type/size of the vehicle, etc. The third sector (102c) may have historical greenhouse gas emissions data (110) relating to the amount and types of produced goods, emissions per product, operating hours, capacity, energy source, raw material, assembly line equipment type, and location of the factory.

The fourth sector (102d) may have historical greenhouse gas emissions data (110) relating to the number of data center servers, routers, switches, generators, power sources, and batteries. The historical greenhouse emissions data (110) may further include any expansion plans, hosting forecast, heavy loads schedules such as backup and software, and CPU/GPU utilization. The fifth sector (102e) may have historical greenhouse gas emissions data (110) relating to community office/residentials building's cooling unit types, power sources/utilization, water consumption, water sources, water cooling towers, water heating, building heating, streetlights, traffic lights, park lights, pump stations, street design, and parking design.

The sixth sector (1020 may have historical greenhouse gas emissions data (110) relating to the construction equipment emissions, construction techniques, project schedule, project plan, generators, and constructors' residents. The seventh sector (102g) may have historical greenhouse gas emissions data (110) relating to combustion engines and energy sources.

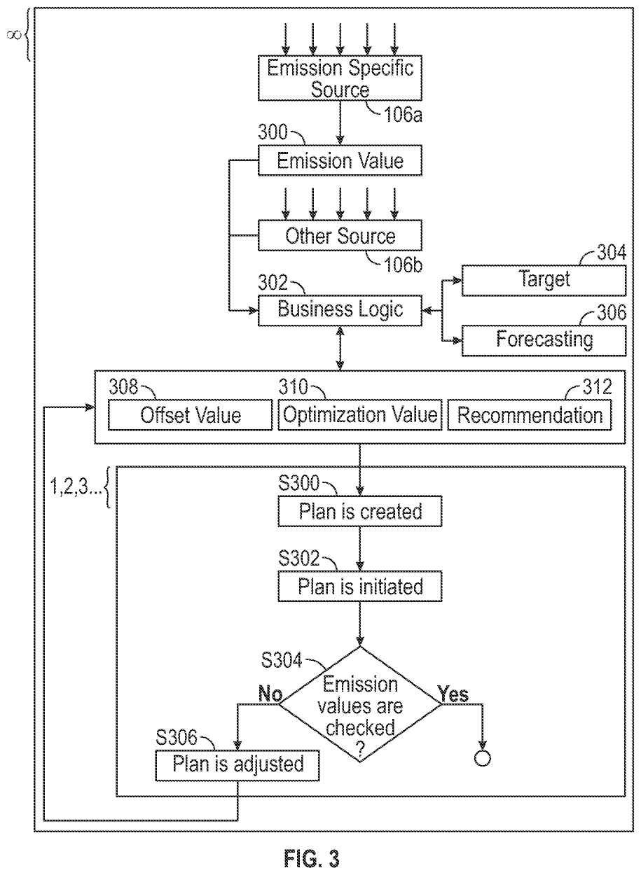

In one or more embodiments, an advanced analytics algorithm is trained with the historical greenhouse gas emissions database (108) (S202). The advanced analytics algorithm may be operated and trained using one or more computer processors (405) located in a computer system. For example, a computer (402) system and associated computer processor (405) are further described in FIG. 4. Further, an example program flowchart of the advanced analytics algorithm (S202) is shown in FIG. 3.

In accordance with one or more embodiments, the advanced analytics algorithm may be one or more predictive algorithms that try to achieve the lowest error possible using “boosting” (a technique which adjusts the weight of an observation based on the last classification) or “bagging” (a technique which creates subsets of data from training samples, chosen randomly with replacement). Further, the advanced analytics algorithm may be artificial intelligence, such as machine learning, which includes computer systems that are able to perform tasks normally requiring human intelligence, such as visual perception, speech recognition, decision-making, and translation between languages. The advanced analytics algorithm may further include hybrid intelligence which combines human intelligence with artificial intelligence such that humans can verify decisions made by the computers.

Continuing with FIG. 2, a recommendation for each sector (102a-g) of the entity (100) is generated using the advanced analytics algorithm (S204). The recommendation may include a number of emission offset devices (104) required to be activated in order to offset the greenhouse gas emissions that are emitted by the sector (102a-g). The emission offset devices (104) may be activated by turning on an emissions offset device (such as a carbon capture and storage device) or by planting an emissions offset device (such as a tree) without departing from the scope of the disclosure herein. The recommendation may also include methods or actions specific to each sector (102a-g) of the entity (100) that may be performed by the sector (102a-g) to optimize/lower greenhouse gas emissions. Further, more than one recommendation may be created for each sector (102a-g) without departing from the scope of the disclosure herein. In accordance with one or more embodiments, training the advanced analytics algorithm and generating the recommendation may be performed by a singular computer processor (402) or training the advanced analytics algorithm may be performed on a first computer processor (402) and generating the recommendation may be performed on a second computer processor (402) without departing from the scope of the disclosure herein.

In accordance with one or more embodiments and for purposes of example only, the method/actions that may be recommended for the first sector (102a) may include the following: choosing a supplier with the lowest greenhouse gas emissions; providing storage that uses green energy sources, providing minimum storage requirements for goods and materials such that there is no heating or cooling of materials that are temperature-resistant; utilizing transportation services that are powered by green energy sources or include a number of energy offset devices (104); using autonomous transportation; optimizing supply trips to increase efficiency of the transportation being used; providing more accurate forecasts of the demand in order to reduce frequency of the transportation of goods and materials; optimizing existing or to be constructed warehouses utilization in terms of the material needed for heating/cooling and other energy demanding requirements; or optimizing the transportation route and schedule using historical and live data feeds (traffic jams, weather conditions, etc.).

The method/actions that may be recommended for the second sector (102b) may include the following: utilizing transportation services that are powered by green energy sources or include a number of energy offset devices (104); using autonomous transportation; optimizing trips to increase efficiency of the transportation being used; providing more accurate forecasts of the demand in order to reduce frequency of the transportation of goods and materials; optimizing the transportation route and schedule using historical and live data feeds (traffic jams, weather conditions, etc.); and improving traffic flow in order to consume less fuel.

The method/actions that may be recommended for the third sector (102c) may include the following: replacing older machines based on energy efficiency evaluations; selecting alternative machines based on eco-friendly measures; selecting raw materials with less production emissions; or rescheduling the standard operation time to save on energy consumption. The method/actions that may be recommended for the fourth sector (102d) may include the following: optimizing code for faster execution to save power energy or scheduling jobs to use better throughout time with less resources' allocation.

The method/actions that may be recommended for the fifth sector (102e) may include the following: replacing appliances with eco-friendly alternatives; embedding humidity sensors to measure when and how much plants should be watered; or using sustainable energy generating methods to mitigate energy consumption. The method/actions that may be recommended for the sixth sector (1020 may include the following: rescheduling working hours; changing the type of generators; suggesting technologies to replace the current design process (such as using 3D printed parts); redesigning the construction workflow; optimizing heavy equipment utilization; or improving construction techniques to optimize time spent on projects. The method/actions that may be recommended for the seventh sector (102g) may include the following: improving the efficiency of machinery used and providing alternatives to reduce the consumption of carbon.

In further embodiments, the recommendation for each sector (102a-g) of the entity (100) may be generated by determining an estimated emissions reduction value for each sector (102a-g) of the entity (100) using the advanced analytics algorithm. That is, the number of recommendations and the details of the recommendation may be based on how much of the emissions are planned to be reduced. The estimated emissions reduction value may be based, in part, on the carbon emissions target that is set, by the advanced analytics algorithm, for the entity (100). The estimated emissions reduction value is applied to each sector's (102a-g) current greenhouse gas emissions (which may be determined using the historical greenhouse gas emissions data (110)) in order to forecast a future emission value for each sector (102a-g) and the entity (100). The recommendations and the forecasting may be cycled through the advanced analytics algorithm before producing a final recommendation.

Each recommendation is applied to each sector (102a-g) of the entity (100) to reduce greenhouse gas emissions (S206). When a recommendation is applied to a sector (102a-g), the advanced analytics algorithm may be updated with the applied recommendation in order to continue to forecast the future emissions values for the sector (102a-g) and entity (100). Further, once the recommendation is applied, the sources (106) may be updated with current emissions data (110) and the current emissions data (110) may be congregated on the database (108) and run through the advanced analytics algorithm to create more recommendations. This process may be repeated, and the estimated emissions reduction values and the associated recommendations may change over time in order to progressively lower/optimize each sector's greenhouse gas emission's values.

FIG. 3 shows a program flowchart of the advanced analytics algorithm in accordance with one or more embodiments. The sources (106) may be categorized as emission specific sources (106a) or other sources (106b), as shown in FIG. 3. Emission values (300) are pulled from the emission specific sources (106a). The emission values (300) and the data pulled from the other sources (106b) make up the historical greenhouse emissions data (110).

The emission specific sources (106a) may be sources that contain emission readings that come directly or indirectly from greenhouse gas emission sources (such as combustion engines). The other sources (106b) may be sources that provide information needed to produce recommendations, optimizations, and offset values such as plans, schedules, figures, etc. For example, the other sources (106b) may include sources that contain shipping schedules, business trip information, cargo delivery, construction dates, time of the year and day, number of workers, number of planted trees, number of cars, etc.

The historical greenhouse emissions data (110) is run through business logic (302) to train the advanced analytics algorithm. The business logic (302) analyzes the emission source (106) and given data to choose the appropriate advanced analytics algorithm (such as artificial intelligence, algorithm model, etc.). The business logic (302) then uses the historical greenhouse emissions data (110) and the chosen advanced analytics algorithm to create emissions targets (304) based off of emissions forecasting (306) for each sector (102a-g).

The business logic (302) compares these values through benchmarking with others in the same business and shares the values with a human reviewer to adjust and modify the values. The emissions targets (304) and forecasting (306), which are part of the business logic (302), aid in determining the offset value (308), optimization value (310), and recommendation (312) needed for each sector (102a-g) in order to reduce the corresponding sector's (102a-g) emissions values by the estimated emissions reduction value. In accordance with one or more embodiments, the targets (304) and forecasting (306) may be performed at the same time as they are part of the business logic (302). In further embodiments, the targets (304) may be adjusted manually.

Once the offset value (308), optimization value (310), and recommendation (312) are determined for each sector (102a-g), a plan is created (S300). The plan is initiated (S302) and the current/new emissions values each sector (102a-g) are checked (S304). If the emissions values are equal to the forecasted emissions, then the process may be completed. If the emissions values of the sector (102a-g) after initiating the plan are not at the forecasted emissions values, then the plan may be adjusted (S306).

The plan is adjusted by uploading the current/new emissions data (110) into the business logic (302) to update the business logic (302) and continue to train the advanced analytics algorithm and produce new offset values (308), optimization values (310), and recommendations (312). The offset values (308), optimization values (310), and recommendations (312) are both feeding the business logic (302) and receiving information from the business logic (302) in a bi-directional relation. Moreover, the number of iterations of adjustment may be any value from 1 to many or many to many.

In accordance with one or more embodiments and for purposes of example only, the second sector's (102b) greenhouse gas emissions may be reduced by determining the amount of greenhouse gas emissions generated by a fleet of cars that the organization owns (this data may be the emission data (110) collected from an emission specific source (106a)). Further the car engine size, fuel type, engine time, weather of the operation, location of the operation, etc. is gathered (this data may be emission data (110) collected from other sources (106b)).

The emission data (110) is fed into the business logic (302). The business logic (302) chooses the appropriate advanced analytics algorithm(s). The chosen advanced analytics algorithm(s) generate a plan that consists of recommendations that include reducing the engine size of the cars by a specific percentage and optimizing routes and rides. The emission target (304) is updated to forecast (306) the reduced number of emissions based off of applying the recommendations. Further, the advanced analytics algorithm calculates the cost associated with executing the plan to reduce the greenhouse gas emissions. This process may be repeated continually until a goal emissions value is achieved.

FIG. 4 shows a computer (402) system in accordance with one or more embodiments. Specifically, FIG. 4 shows a block diagram of a computer (402) system used to provide computational functionalities associated with described algorithms, methods, functions, processes, flows, and procedures as described in the instant disclosure, according to an implementation. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device.

Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402).

The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a non-transitory computer (402) readable medium, or a memory (406), that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method for reducing greenhouse gas emissions, the method comprising:
building, using a computer processor, a historical greenhouse gas emissions database by integrating historical greenhouse gas emissions data from a plurality of sources for a plurality of sectors in an entity;
training, using the computer processor, an advanced analytics algorithm with the historical greenhouse gas emissions database;
generating, using the computer processor and the advanced analytics algorithm, a recommendation for each sector of the entity; and
applying each recommendation to each sector of the entity to reduce greenhouse gas emissions.

2. The method of claim 1, wherein generating the recommendation for each sector of the entity further comprises determining an estimated emission reduction value for each sector of the entity using the advanced analytics algorithm.

3. The method of claim 2, wherein generating the recommendation for each sector of the entity further comprises applying the estimated emission reduction value for each sector of the entity to each sector's current greenhouse gas emission.

4. The method of claim 3, wherein determining the estimated emission reduction value for each sector further comprises setting a carbon emission target using the advanced analytics algorithm.

5. The method of claim 1, wherein training the advanced analytics algorithm further comprises updating the advanced analytics algorithm with each applied recommendation.

6. The method of claim 5 further comprising:
forecasting a future emission value for each sector using the advanced analytics algorithm updated with each applied recommendation.

7. The method of claim 1, wherein the plurality of sources comprise two or more sources selected from a group comprising: Internet of Things, Plant Information, Web APIs restful and SOAP, Building Management Systems, ERP systems, AVL, GIS, Excel sheets, video cameras, remote sensors, satellite imaging, digital documents, Non-ERP Systems, scanned documents, SCADA, text files, and user sources.

8. The method of claim 1, wherein the recommendation comprises activating one or more emission offset devices.

9. The method of claim 8, wherein the one or more emission offset devices comprise one or more devices from a group comprising: direct air capture devices, trees, and carbon capture and storage devices.

10. The method of claim 1, wherein the recommendation comprises optimizing greenhouse gas emissions using methods specific to each sector of the entity.

11. A system comprising:
an entity comprising a plurality of sectors, wherein each sector has historical greenhouse gas emissions data retrieved from a plurality of sources;
a plurality of emission offset devices; and
a non-transitory computer readable medium coupled to the plurality of sources and the plurality of emission offset devices, the non-transitory computer readable medium storing instructions comprising functionality for:
building a historical greenhouse gas emissions database by integrating the historical greenhouse gas emissions data from the plurality of sources for the plurality of sectors in the entity;
training an advanced analytics algorithm with the historical greenhouse gas emissions database;
generating, using the advanced analytics algorithm, a recommendation for each sector of the entity; and
applying each recommendation to each sector of the entity to reduce greenhouse gas emissions.

12. The system of claim 11, wherein generating the recommendation for each sector of the entity further comprises determining an estimated emission reduction value for each sector of the entity using the advanced analytics algorithm.

13. The system of claim 12, wherein generating the recommendation for each sector of the entity further comprises applying the estimated emission reduction value for each sector of the entity to each sector's current greenhouse gas emission.

14. The system of claim 13, wherein determining the estimated emission reduction value for each sector further comprises setting a carbon emission target using the advanced analytics algorithm.

15. The system of claim 11, wherein training the advanced analytics algorithm further comprises updating the advanced analytics algorithm with each applied recommendation.

16. The system of claim 15 further comprising:
forecasting a future emission value for each sector using the advanced analytics algorithm updated with each applied recommendation.

17. The system of claim 11, wherein the plurality of sources comprise two or more sources selected from a group comprising: Internet of Things, Plant Information, Web APIs restful and SOAP, Building Management Systems, ERP systems, AVL, GIS, Excel sheets, video cameras, remote sensors, satellite imaging, digital documents, Non-ERP Systems, scanned documents, SCADA, text files, and user sources.

18. The system of claim 11, wherein the recommendation comprises activating one or more of the plurality of emission offset devices.

19. The system of claim 18, wherein the plurality of emission offset devices comprise one or more devices from a group comprising: direct air capture devices, trees, and carbon capture and storage devices.

20. The system of claim 11, wherein the recommendation comprises optimizing greenhouse gas emissions using methods specific to each sector of the entity.
